(19) United States
(12) Patent Application Publication
(10) Pub. No.: US 2015/0042401 A1
(43) Pub. Date: Feb. 12, 2015

(54) PASSING HIGH VOLTAGE INPUTS USING A CONTROLLED FLOATING PASS GATE

(71) Applicant: QUALCOMM INCORPORATED, San Diego, CA (US)

(72) Inventors: Stephen Knol, San Diego, CA (US); Michael Brunolli, Escondido, CA (US); Chiew-Guan Tan, San Diego, CA (US); Damen Redelings, San Diego, CA (US)

(73) Assignee: QUALCOMM INCORPORATED, San Diego, CA (US)

(21) Appl. No.: 13/962,742

(22) Filed: Aug. 8, 2013

(51) Int. Cl. G05F 3/24

(52) U.S. Cl. CPC G05F 3/242
USPC 327/543

(57) ABSTRACT

An input receiver includes a first pass transistor coupled between an input pad and an internal receiver node. The first pass transistor includes a controlled floating gate capacitively coupled to the input pad. A source follower transistor couples between the internal receiver node and a power supply. A gate for the source follower transistor couples to the input pad.

### TECHNICAL FIELD

This application relates to input receivers configured to receive high input voltages using standard non-native devices.

### BACKGROUND

As semiconductor technology has advanced into the deep submicron regime, the power supply voltage is scaled down in concert with the scaling down of transistor dimensions. Nevertheless, input/output (I/O) standards from higher voltage regimes may still need to be supported. But the thin-oxide transistors in modern high-density integrated circuits may not be able to accommodate more than two volts across their gate-source, gate-drain, or source-drain junctions. To safely receive input voltages that exceed such maximum values, it is conventional to use native transistors in the integrated circuit's input receiver.

An example input receiver 100 is shown in FIG. 1A. A native pass transistor 105 has its gate driven by the internal power supply voltage VDD and receives at its drain an input voltage from an input pad (not illustrated). This input voltage may transition to exceed VDD to a level that is unsafe for input receiver 100 as well as to downstream devices in the associated integrated circuit. As the input pad voltage rises, the source voltage for native transistor 105 rises as well. But the source voltage cannot rise higher than VDD minus the threshold voltage for native transistor 105. If VDD equals 1.8 V and if the threshold voltage is 100 mV, then the source voltage cannot rise higher than 1.7 V. This source voltage is thus at a safe level to be processed by inverter 110 to form an input signal to be driven to downstream devices within the associated integrated circuit. In contrast, if transistor 105 were replaced by a standard NMOS transistor, its threshold voltage is considerably higher such that the source voltage could not exceed, for example, 1.3 V. The source voltage would then be too low to reliably trigger inverter 110 across all process corners such that the resulting internal input signal becomes error prone.

But modern deep sub-micron semiconductor processes do not support the production of native transistors. To accommodate the use of a standard (non-native) NMOS pass transistor 120 as shown for an input receiver 115 in FIG. 1B, a source follower NMOS transistor 135 may be included that has its gate coupled to an input node 125 receiving the input pad voltage. As discussed with regard to input receiver 100, the source voltage for pass transistor 120 would not rise higher than around 1.3 V if VDD equals 1.8 V without further assistance. But source follower transistor 135 allows more of the input pad voltage to pass as may be better understood with reference to FIG. 1C, which shows an input pad voltage 140 and a source voltage 145 for pass transistor 120 (this source voltage is also the input voltage to inverter 110). As input pad voltage 140 rises from ground to 1.3 V, source voltage 145 rises in concert. But at 1.3 V, pass transistor 120 has done all it can do for the rise in the source voltage 145. Source follower transistor 135 cannot turn on until input pad voltage 140 is a threshold above this source voltage (approximately 1.8 V). As input pad voltage 140 continues to rise past this level, source voltage 145 for source follower transistor 135 will “follow” this increase until the VDD level is reached (in this embodiment, 1.8 V). But the lag encountered at 1.3V until source follower transistor 135 turns on may lead to input signal errors from inverter 110 as the switching speed for the input signal is increased.

Accordingly, there is a need in the art for improved input receivers for modern semiconductor processes.

### SUMMARY

An input receiver includes a first pass transistor coupled between an input receiver node and an input pad configured to carry an input pad voltage. The first pass transistor includes a floating gate configured to capacitively couple to the input pad. As used herein, the floating gate for the first pass transistor is deemed as a “controlled” floating gate since it is allowed to float only between a minimum voltage and a maximum voltage. To provide this control in one embodiment, the floating gate couples through a pair of diode-connected transistors to a power supply providing a power supply voltage (VDD). A first one of the diode-connected transistors has its cathode coupled to the floating gate and its anode coupled to the power supply. The first diode-connected transistor thus prevents the floating gate voltage from falling below VDD minus a threshold voltage for the first diode-connected transistor. Conversely, a second one of the diode-connected transistors has its cathode coupled to the power supply and its anode coupled to the floating gate. The second diode-connected transistor thus prevents the floating gate voltage from rising more than a threshold voltage for the second diode-connected transistor above VDD. Alternatively, a single diode-connected transistor may be used to control the floating gate voltage in conjunction with its parasitic body diode. In yet another alternative embodiment, the floating gate voltage may be controlled through a pair of well diodes.

The input receiver includes an NMOS source follower transistor having a first drain/source terminal coupled to the power supply and a second drain/source terminal coupled to the input receiver node. A gate for the source follower transistor is coupled to the input pad. As the input pad voltage rises, it turns on the source follower transistor to assist charging the input receiver node to VDD. The second terminal thus acts as a source for the NMOS source follower transistor as the voltage for the input receiver node rises to VDD. However, the capacitive coupling of the input pad voltage to the floating gate voltage for the first pass transistor would, in the absence of the source follower transistor, boost the input receiver node voltage above VDD as the input pad voltage continues to rise above VDD. Such a heightened voltage for the input receiver node voltage could damage circuitry downstream to the input receiver node. But the source follower transistor clamps the input receiver node voltage from rising above VDD. During this clamping stage, the second terminal of the source follower transistor acts as a drain. For this reason, the first and second terminals for the source follower transistor are denoted herein as source/drain terminals in that their function changes as the current reverses direction in the source follower transistor. The first pass transistor includes a first terminal coupled to the input pad and a second terminal coupled to the input receiver node that may both be denoted as source/drain terminals in that the direction of current flow through the pass transistor also alternates directions.

### BRIEF DESCRIPTION OF THE DRAWINGS

FIG. 1A is a schematic diagram for a conventional input receiver having a native pass transistor.

FIG. 1B is a schematic diagram for an input receiver including a non-native pass transistor aided by a source follower transistor.

FIG. 1C is a signal diagram for an input pad voltage and an internal node voltage for the input receiver of FIG. 1B.

FIG. 2A is a schematic diagram for an input receiver in which a floating gate for a pass transistor couples to a power supply through diode-connected NMOS transistors.

FIG. 2B is a signal diagram for an input pad voltage, a floating gate voltage, and an internal node voltage for the input receiver of FIG. 2A.

FIG. 3A is a schematic diagram of an input receiver in which a floating gate for a pass transistor couples to a power supply through diode-connected PMOS transistors.

FIG. 3B is a schematic illustration of an input receiver in which a floating gate for a pass transistor couples to a power supply through a single diode-connected PMOS transistor.

FIG. 3C is a schematic illustration of an input receiver in which a floating gate for a pass transistor couples to a power supply through a pair of well diodes.

FIG. 4 is a flowchart for an example method of operation for an input receiver in accordance with an embodiment of the disclosure.

Embodiments of the present invention and their advantages are best understood by referring to the detailed description that follows. It should be appreciated that like reference numerals are used to identify like elements illustrated in one or more of the figures.

### DETAILED DESCRIPTION

To meet this need for improved input receivers, an input receiver for passing an input pad voltage is provided that includes a first pass transistor having a floating gate that is controlled to float between a maximum voltage and a minimum voltage. In one embodiment, the maximum voltage is approximately one transistor threshold voltage (Vt) above a power supply voltage (VDD) whereas the minimum voltage is approximately one Vt below VDD. For example, suppose VDD is 1.8 V and the input pad voltage cycles between zero and 3.3 V. If the input pad voltage is falling to ground, then the floating gate voltage will fall until it is clamped at VDD−Vt, which is approximately 1.3 V in one embodiment. The floating gate voltage is thus controlled to float between a minimum voltage such as VDD−Vt and a maximum voltage such as VDD+Vt.

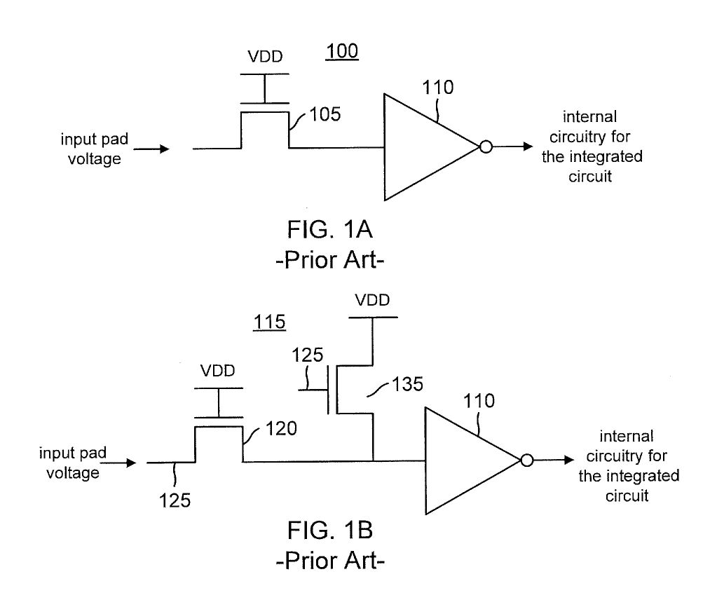

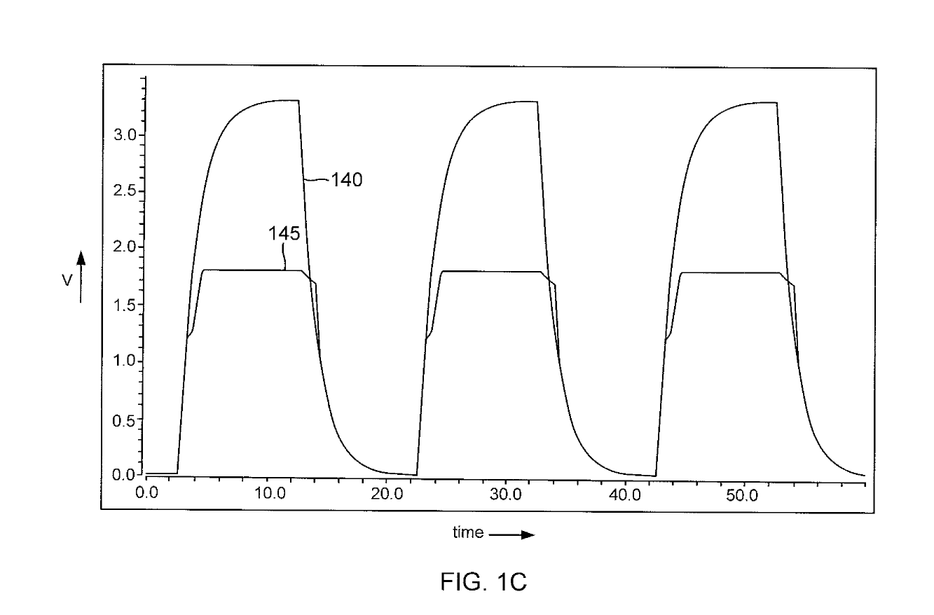

The first pass transistor couples through a first drain/source terminal to an input pad that carries the input pad voltage. The floating gate capacitively couples to the input pad such that the floating gate voltage rises from the minimum voltage as the input pad voltage rises. For example, as the input pad voltage rises to 0.5 V, the floating gate voltage rises to the minimum value plus 0.5 V. As the floating gate continues to rise to 1 V, the floating gate voltage rises to the minimum value plus 1 V, and so on until the floating gate voltage is clamped at the maximum value. This relatively high floating gate voltage enables the first pass transistor to efficiently pass the rising edge of the input pad voltage to an input receiver node coupled to a second drain/source terminal for the first pass transistor. In this fashion, the lag issue in the rising edge for the passed voltage discussed above with regard to FIG. 1C is eliminated. In other words, more of the rising edge for the input pad voltage is passed through the first pass transistor. The first pass transistor also allows a falling edge for the input receiver node voltage to substantially follow the falling edge for the input pad voltage.

A source follower transistor couples between a power supply providing VDD and the input receiver node. The gate of the source follower transistor couples to the input pad. Because of the relatively high floating gate voltage for the first pass transistor that is induced as the input pad voltage rises, the first pass transistor could boost the input receiver node voltage above VDD to potentially unsafe levels for downstream circuitry to the input receiver node. The source follower transistor clamps the input receiver node voltage at VDD and thus protects against this potential for excessive internal voltage. Some example embodiments will now be discussed in more detail.

### Example Embodiments

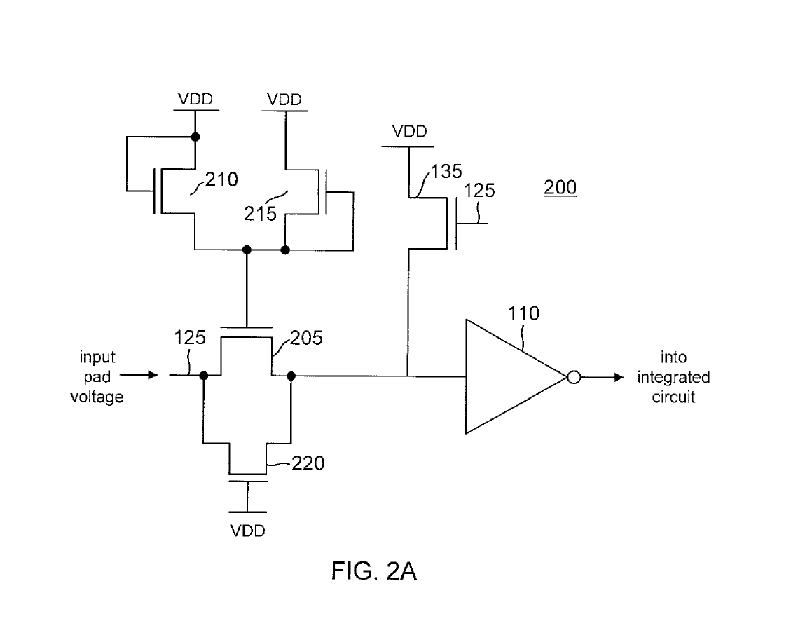

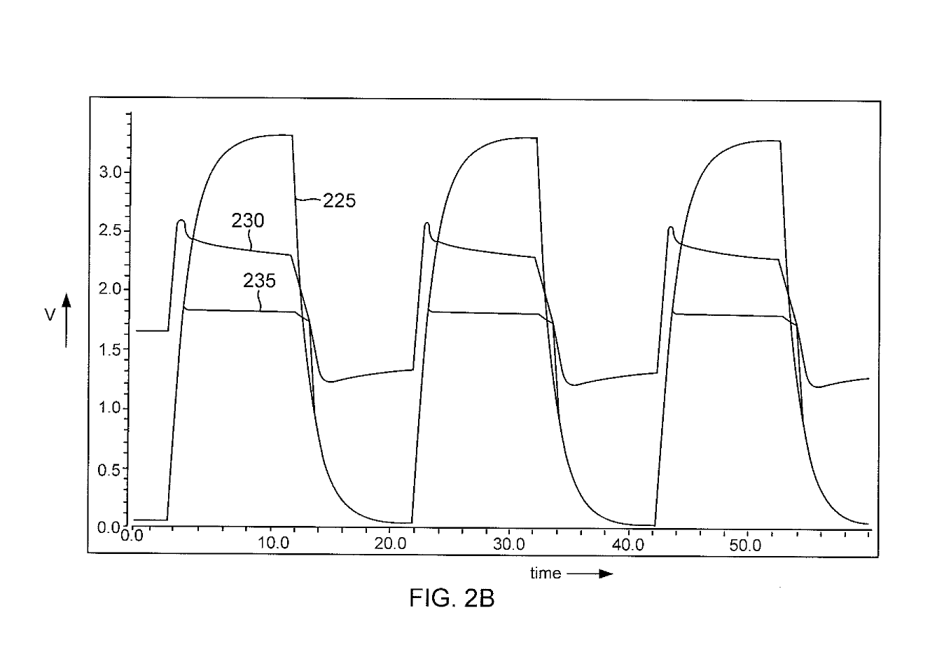

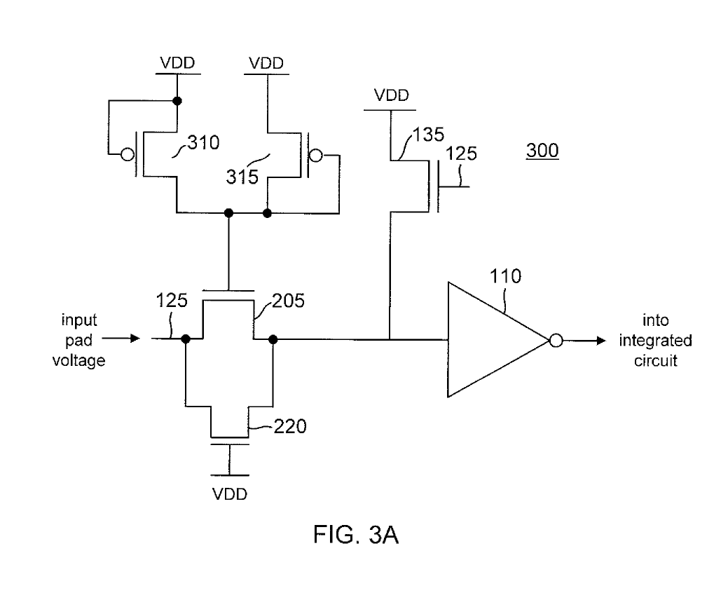

An example input receiver 200 is shown in FIG. 2A that needs no native devices. NMOS source follower transistor 135 and inverter 110 are configured as discussed with regard to input receiver 115. NMOS source follower transistor 135 thus has a gate coupled to an input pad 125. In this embodiment, the input to inverter 110 serves as the input receiver node that is biased by a standard NMOS first pass transistor 205. A floating gate voltage for first pass transistor 205 is controlled by a first diode-connected NMOS transistor 210 and a second diode-connected NMOS transistor 215. Although these transistors are both diode connected, they are of reversed polarity. Thus, the drain of first diode-connected transistor 210 couples to the power supply node VDD whereas the drain of second diode-connected transistor 215 couples to the floating gate of first pass transistor 205. In this fashion, the diode formed by second-diode connected transistor 215 will be forward biased and conducting if the floating gate for first pass transistor 205 rises a Vt above VDD. An anode voltage for this diode is thus the floating gate voltage for pass transistor 205. Similarly, the diode formed by first diode-connected transistor 210 will be forward biased and conducting if the floating gate for pass transistor 205 falls a Vt below VDD. The cathode voltage for the diode formed by first diode-connected transistor 210 is thus the floating gate voltage for first pass transistor 205. In this fashion, the floating gate voltage is controlled to float only in the region from approximately (VDD−Vt) to (VDD+Vt). First diode-connected transistor 210 clamps the floating gate voltage from falling any lower than approximately (VDD−Vt) whereas second diode-connected transistor 215 substantially clamps the floating gate voltage from rising any higher than approximately (VDD+Vt). The floating gate voltage is not only prevented from rising to dangerous levels as the input pad voltage rises but is also prevented from falling too low so as to keep first pass transistor 205 conducting to allow the input voltage to inverter 110 to fall as the input pad voltage falls. In addition, clamping the floating gate voltage to substantially no lower than VDD−Vt allows the capacitive coupling from the input pad voltage to rapidly push the floating gate voltage towards VDD+Vt to assist in biasing the input to inverter 110 as the input pad voltage rises.

The benefit from the capacitive coupling of the input pad voltage to the floating gate voltage may be better understood with reference to the voltage waveforms for input receiver 200 as shown in FIG. 2B. The input pad voltage 225 periodically rises to above 3 volts and falls back to ground. As input pad voltage 225 rises from ground, the floating gate voltage 230 for first pass transistor 205 rises from the minimum value such as VDD−Vt (instead of ground) because of the voltage clamping provided by first diode-connected transistor 210. Floating gate voltage 230 will thus rise from VDD−Vt as input pad voltage 225 rises. For example, as input pad voltage 225 rises to 0.5 V, floating gate voltage 230 rises to VDD−Vt+0.5V. In this fashion, floating gate voltage 230 will lead input pad voltage 225 so as to rise to a maximum value such as VDD+Vt before input pad voltage 225 rises to this level. The floating gate for first pass transistor 205 may also be denoted as a controlled floating gate because of its diode-limited maximum and minimum voltage values.

The capacitive coupling to the floating gate eliminates the delay or lag in the rising edge of an inverter input voltage 235 that was seen for source voltage 145 of FIG. 1C. Although there is no fixed source or drain for first pass transistor 205, because the second source/drain terminal acts as a source while input pad voltage 225 rises, inverter input voltage 235 may also be denoted as a source voltage for first pass transistor 205. Note that first diode-connected transistor 210 prevents floating gate voltage 230 from falling below VDD−Vt. As input pad voltage 225 rises from ground, floating gate voltage 230 rises from VDD−Vt until it is substantially clamped at approximately VDD+Vt by second diode-connected transistor 215. In an embodiment in which VDD is 1.8 V and Vt is 0.5 V, the sum of VDD and Vt is approximately 2.3 V. But as shown in FIG. 2B, the capacitive coupling on floating gate voltage 230 is such that it initially boosts past this value to above 2.5 V before second diode-connected transistor can fully turn on and pull the floating gate voltage back to approximately 2.3 V. For this reason, the floating gate voltage is denoted herein as being prevented from rising substantially above a sum of VDD and Vt. Input pad voltage 225 equals approximately VDD (1.8 V) as floating gate voltage crests at 2.5 V. As input pad voltage 225 rises above VDD, inverter input voltage 235 can thus readily increase past VDD, which could strain inverter 110. But NMOS source follower transistor 135 turns on and prevents source voltage 235 from rising past VDD. It will thus be appreciated that the role of source follower transistor 135 is no longer really that of aiding a boost in inverter input voltage 235 since the rising edge for input pad voltage 225 is robustly mirrored by the rising edge for inverter input voltage 235 due to the action of first pass transistor 205 with its controlled floating gate voltage 230. Instead source follower transistor 135 acts to clamp inverter input voltage 235 from rising past VDD. The end result as shown in FIG. 2B is that the rising edge in inverter input voltage 235 has essentially zero lag with regard to the rising edge of input pad voltage 225 until inverter input voltage 235 is clamped at VDD.

The falling edge for inverter input voltage 235 has some falling edge lag with regard to the falling edge of input pad voltage 225 but this is not problematic due to the hysteresis in inverter 110. Moreover, a standard second NMOS pass transistor 220 may couple in parallel with first pass transistor 205 between the input pad and the inverter input and has its gate tied to VDD to minimize lag in the falling edge for inverter input voltage 235. Although floating gate voltage 230 is inhibited from falling below VDD−Vt, such a gate voltage does not allow inverter input voltage 235 to follow the falling edge of input pad voltage 225 as robustly as does the gate voltage of VDD for second pass transistor 220. Moreover, second pass transistor 220 also aids in passing falling and leading edges in input pad voltage 225 during DC or very slowly changing conditions. Advantageously, all the devices in input receiver 200 may comprise thin-oxide transistors despite the receipt of voltages above VDD.

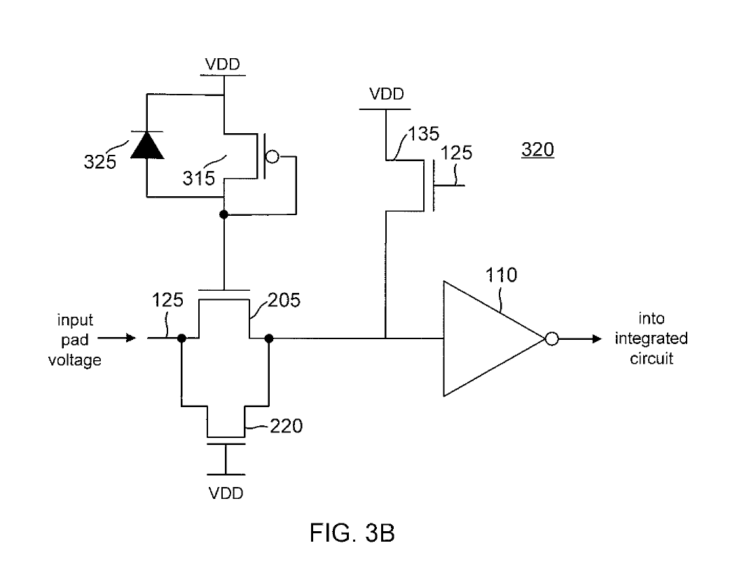

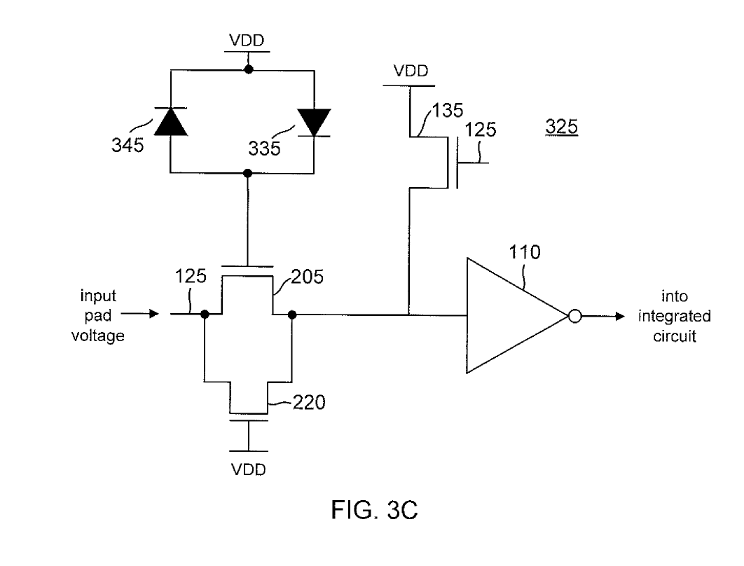

An alternative embodiment is shown in FIG. 3A for an input receiver 300 in which the floating gate for pass transistor 205 couples to the power supply node VDD through a pair of diode-connected PMOS transistors 310 and 315 instead of through a pair diode-connected NMOS transistors as discussed with regard to input receiver 200. Note that the behavior of diode-connected PMOS transistors 310 and 315 is complementary to that for diode-connected NMOS transistors 210 and 215. In both embodiments, the gate for each diode-connected transistor couples to its drain. Thus, diode-connected PMOS transistor 310 serves to prevent the floating gate voltage from rising substantially above the sum of VDD and its threshold voltage such that the floating gate functions as the anode for diode-connected PMOS transistor 310. Conversely, diode-connected PMOS transistor 315 functions to prevent the floating gate voltage from falling substantially below the difference between VDD and its threshold voltage such that the floating gate functions as the cathode for diode-connected PMOS transistor 315. The remainder of input receiver 300 functions as discussed with regard to input receiver 200.

In an alternative embodiment, diode-connected PMOS transistor 310 may be eliminated as shown for an input receiver 320 of FIG. 3B. In that regard, it is known that a parasitic body diode exists at the source and drain for any FET. In input receiver 320, diode 325 represents the parasitic body diode between the drain of diode-connected PMOS transistor 315 and the power supply node VDD. The floating gate voltage for pass transistor 205 will thus be prevented from rising substantially above the sum of VDD and the forward bias voltage for parasitic body diode 325. The remainder of input receiver 320 operates as discussed above with regard to input receiver 300.

In yet another alternative embodiment, the floating gate voltage for pass transistor 205 may be controlled by a pair of well diodes 345 and 335 as shown in FIG. 3C for an input receiver 325. Well diode 345 functions to prevent the floating gate voltage from rising substantially above VDD plus its forward bias voltage. Similarly, well diode 335 functions to prevent the floating gate voltage from falling substantially below VDD minus its forward bias voltage. The remainder of input receiver 320 functions as discussed with regard to input receivers 300 and 200. An example method of operation for the input receivers disclosed herein will now be discussed.

### Example Method of Operation

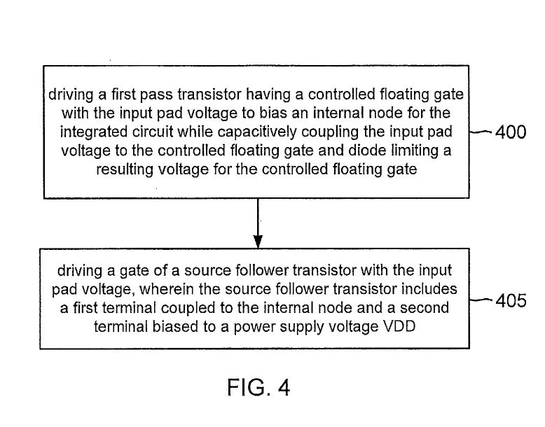

A flowchart for an example method of operation for receiving an input pad voltage for an integrated circuit as disclosed herein is shown in FIG. 4. The method includes an act 400 of driving a first pass transistor having a controlled floating gate with the input pad voltage to bias an internal node for the integrated circuit while capacitively coupling the input pad voltage to the controlled floating gate and diode limiting a resulting voltage for the controlled floating gate. Referring again to input receiver 200 of FIG. 2C, an example internal node is the input node to inverter 110. However, it will be appreciated that other types of internal nodes may receive a passed version of the input pad voltage in this fashion. The method also includes an act 405 of driving a gate of a source follower transistor with the input pad voltage, wherein the source follower transistor includes a first terminal coupled to the internal node and a second terminal biased to a power supply voltage VDD.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

1. A circuit, comprising:
a non-native first pass transistor coupled between an input pad and an input receiver node, wherein the non-native first pass transistor includes a floating gate coupled to a power supply through a pair of diodes; and
a source follower transistor having its gate coupled to the input pad, a first drain/source terminal coupled to the input receiver node, and a second drain/source terminal coupled to the power supply.

2. The circuit of claim 1, wherein the pair of diodes comprises:
a first diode-connected transistor coupled between the floating gate and the power supply; and
a second diode-connected transistor coupled between the floating gate and the power supply, wherein the first diode-connected transistor is configured to have its cathode coupled to the floating gate and the second diode-connected transistor is configured to have its anode coupled to the floating gate.

3. The circuit of claim 1, further comprising a non-native second pass transistor coupled between the input pad and the input receiver node, wherein a gate for the non-native second pass transistor is coupled to the power supply.

4. The circuit of claim 2, wherein the first diode-connected transistor and the second diode-connected transistor comprise diode-connected NMOS transistors.

5. The circuit of claim 2, wherein the first diode-connected transistor and the second diode-connected transistor comprise diode-connected PMOS transistors.

6. The circuit of claim 1, wherein the pair of diodes comprises a diode-connected transistor and a parasitic body diode for the diode-connected transistor.

7. The circuit of claim 3, wherein the source follower transistor, the non-native first pass transistor, and the non-native second pass transistors all comprise NMOS transistors.

8. A method of receiving an input pad voltage at an integrated circuit, comprising:
driving a non-native first pass transistor having a controlled floating gate with the input pad voltage to bias an internal node for the integrated circuit while capacitively coupling the input pad voltage to the controlled floating gate and diode limiting a resulting voltage for the controlled floating gate; and
driving a gate of a source follower transistor with the input pad voltage, wherein the source follower transistor includes a first terminal coupled to the internal node and a second terminal biased to a power supply voltage VDD.

9. The method of claim 8, further comprising driving a non-native second pass transistor with the input pad voltage to further bias the internal node, wherein the non-native second pass transistor includes a gate biased to the power supply voltage VDD.

10. The method of claim 8, wherein diode limiting the voltage for the controlled floating gate comprises diode limiting through a first diode-connected transistor having a cathode coupled to the controlled floating gate and diode limiting through a second diode-connected transistor having an anode coupled to the floating gate.

11. The method of claim 10, wherein diode limiting the voltage for the controlled floating gate comprises preventing the voltage for the controlled floating gate from rising substantially above a sum of the power supply voltage VDD and a threshold voltage for the second diode-connected transistor and preventing the voltage for the controlled floating gate from falling substantially below a difference between the power supply voltage VDD and a threshold voltage for the first diode-connected transistor.

12. The method of claim 8, wherein diode limiting the voltage for the controlled floating gate comprises diode limiting through a pair of well diodes.

13. The method of claim 8, further comprising inverting a voltage for the internal node to produce an inverter output voltage.

14. (canceled)

15. The method of claim 8, wherein driving the gate of the source follower transistor comprises driving a gate of an NMOS source follower transistor.

16. The method of claim 9, wherein driving the gate of the non-native second pass transistor comprises driving a source/drain terminal of a non-native NMOS second pass transistor.

17. A circuit, comprising:
a non-native first pass transistor coupled between an input pad and an input receiver node, wherein the non-native first pass transistor includes a controlled floating gate;
means for controlling a voltage for the controlled floating gate from falling below a minimum voltage and from rising above a maximum voltage; and
a source follower transistor having its gate coupled to the input pad, a first drain/source terminal coupled to the input receiver node, and a second drain/source terminal coupled to a power supply.

18. The circuit of claim 17, further comprising a non-native second pass transistor coupled between the input pad and the input receiver node, wherein a gate for the second pass transistor is coupled to the power supply.

19. (canceled)

20. The circuit of claim 18, further comprising an inverter, wherein the input receiver node is an input node to the inverter.
